(19) United States
(12) Patent Application Publication
(10) Pub. No.: US 2023/0182814 A1
(43) Pub. Date: Jun. 15, 2023

(54) STEERING WHEEL ATTACHMENT DEVICE

(71) Applicant: Doo Hwang, Sarasota, FL (US)

(72) Inventor: Doo Hwang, Sarasota, FL (US)

(21) Appl. No.: 17/548,810

(22) Filed: Dec. 13, 2021

(51) Int. Cl. B62D 15/02; B62D 1/04; B62D 6/00

(52) U.S. Cl. CPC B62D 15/029; B62D 1/04; B62D 6/00

(57) ABSTRACT

A steering wheel attachment device removably connected to at least a portion of a steering wheel of a vehicle, the steering wheel attachment device including a main body, and a pressure dissemination unit disposed within at least a portion of the main body to provide a pressured sensation to the steering wheel corresponding to a touch by a user.

### BACKGROUND

### 1. Field

The present general inventive concept relates generally to a steering wheel, and particularly, to a steering wheel attachment device.

### 2. Description of the Related Art

Electric vehicles (EVs) are steadily rising in popularity among consumers of vehicles. The gradual decline of availability of petroleum as a source of fuel has contributed to rapid advancement of electric vehicles. Moreover, some electric vehicles and/or automakers are developing self-driving software for the electric vehicle.

An early version of the self-driving software provides an autopilot that allows the electric vehicle to perform basic driving functions, such as changing lanes on a highway, accelerating, and/or braking. However, the autopilot requires a driver to be actively participating during driving by periodically touching a steering wheel every thirty seconds. The autopilot will disengage if the steering wheel does not receive physical contact by the driver after a period of time. Unfortunately, the requirement to touch the steering wheel during the autopilot is an inconvenience for the driver and often requires them to upgrade to full self-driving which is expensive and has limited access.

Therefore, there is a need for a steering wheel attachment device that simulates touch by the driver to the steering wheel during use of the autopilot.

### SUMMARY

The present general inventive concept provides a steering wheel attachment device.

Additional features and utilities of the present general inventive concept will be set forth in part in the description which follows and, in part, will be obvious from the description, or may be learned by practice of the general inventive concept.

The foregoing and/or other features and utilities of the present general inventive concept may be achieved by providing a steering wheel attachment device removably connected to at least a portion of a steering wheel of a vehicle, the steering wheel attachment device including a main body, and a pressure dissemination unit disposed within at least a portion of the main body to provide a pressured sensation to the steering wheel corresponding to a touch by a user.

The steering wheel attachment device may further include a sensor disposed within at least a portion of the main body to detect at least one of at least one sound from the vehicle corresponding to an autopilot warning of the vehicle and at least one movement of the steering wheel corresponding to the autopilot warning while an autopilot operation of the vehicle is activated.

The steering wheel attachment device may further include a control unit disposed within at least a portion of the main body to control the pressured sensation from the pressure dissemination unit.

The control unit may send a signal to the pressure dissemination unit to continue using the pressured sensation for a predetermined period of time to satisfy a requirement of the autopilot operation to touch the steering wheel.

### BRIEF DESCRIPTION OF THE DRAWINGS

These and/or other features and utilities of the present generally inventive concept will become apparent and more readily appreciated from the following description of the embodiments, taken in conjunction with the accompanying drawings of which:

FIG. 1 illustrates a top perspective of a steering wheel attachment device, according to an exemplary embodiment of the present general inventive concept; and

FIG. 2 illustrates an elevational front view of the steering wheel attachment device as disposed on a steering wheel, according to an exemplary embodiment of the present general inventive concept.

### DETAILED DESCRIPTION

Various example embodiments (a.k.a., exemplary embodiments) will now be described more fully with reference to the accompanying drawings in which some example embodiments are illustrated. In the figures, the thicknesses of lines, layers and/or regions may be exaggerated for clarity.

Accordingly, while example embodiments are capable of various modifications and alternative forms, embodiments thereof are shown by way of example in the figures and will herein be described in detail. It should be understood, however, that there is no intent to limit example embodiments to the particular forms disclosed, but on the contrary, example embodiments are to cover all modifications, equivalents, and alternatives falling within the scope of the disclosure. Like numbers refer to like/similar elements throughout the detailed description.

It is understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art. However, should the present disclosure give a specific meaning to a term deviating from a meaning commonly understood by one of ordinary skill, this meaning is to be taken into account in the specific context this definition is given herein.

List of Components
Steering Wheel Attachment Device 100
Main Body 110
Sensor 120
Pressure Dissemination Unit 130
Control Unit 140
Power Source 150
Fastener 160

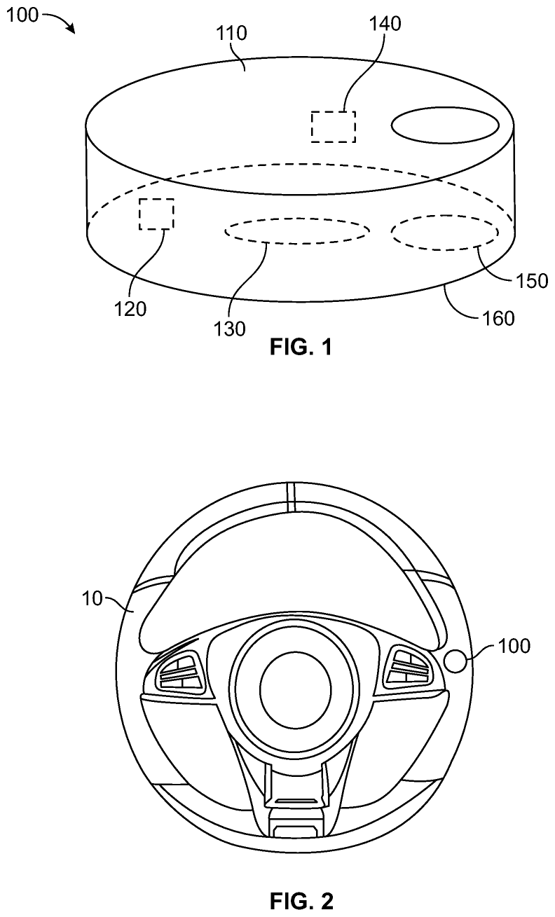

FIG. 1 illustrates a top perspective of a steering wheel attachment device 100, according to an exemplary embodiment of the present general inventive concept.

FIG. 2 illustrates an elevational front view of the steering wheel attachment device 100 as disposed on a steering wheel 10, according to an exemplary embodiment of the present general inventive concept.

The steering wheel attachment device 100 may be constructed from at least one of metal, plastic, wood, and rubber, etc., but is not limited thereto.

The steering wheel attachment device 100 may include a main body 110, a sensor 120, a pressure dissemination unit 130, a control unit 140, a power source 150, and a fastener 160, but is not limited thereto.

Referring to FIGS. 1 and 2, the main body 110 is illustrated to have a cylindrical shape. However, the main body 110 may be rectangular, circular, spherical, triangular, pentagonal, hexagonal, heptagonal, octagonal, or any other shape known to one of ordinary skill in the art, but is not limited thereto.

The main body 110 may be removably connected to at least a portion of a steering wheel 10 of a vehicle.

The sensor 120 may include a motion sensor and a sound sensor, but is not limited thereto.

The sensor 120 may be disposed within at least a portion of the main body 110. The sensor 120 may detect at least one sound from the vehicle corresponding to an autopilot warning of the vehicle and/or at least one movement (e.g., vibration based on autopilot operation) of the steering wheel 10 corresponding to the autopilot warning. More specifically, the sensor 120 may be configured to detect the at least one sound from the vehicle and/or the at least one movement of the steering wheel 10 while an autopilot operation of the vehicle is activated. In other words, the sensor 120 may remain inactive during normal steering by a user and/or other sounds in the vehicle, such as a radio, conversation, and/or any other sounds unrelated to the autopilot operation. Accordingly, the sensor 120 may send a pressure signal in response to detecting the at least one sound from the vehicle and/or the at least one movement of the steering wheel 10 corresponding to the autopilot warning.

The pressure dissemination unit 130 may include various devices to simulate a vibration effect, including, but not limited to vibration devices, pistons, mechanical rollers, compression devices, stretching devices, kneading devices, pressing devices, oscillators, gears, etc.

The pressure dissemination unit 130 may be disposed within at least a portion of the main body 110. As such, the pressure dissemination unit 130 may provide a pressured sensation to the steering wheel 10 in response to receiving the pressure signal from the sensor 120. Furthermore, the pressure dissemination unit 130 may provide the pressure sensation corresponding to (i.e., identical to) a touch by the user (e.g., a hand, an arm, a wrist, etc.). In other words, the pressure dissemination unit 130 may simulate the hand of the user on the steering wheel 10.

The control unit 140 may include a processing unit and a storage unit, but is not limited thereto.

The processing unit of the control unit 140 (or central processing unit, CPU) may include electronic circuitry to carry out instructions of a computer program by performing basic arithmetic, logical, control and input/output (I/O) operations specified by the instructions. The processing unit of the control unit 140 may include an arithmetic logic unit (ALU) that performs arithmetic and logic operations, processor registers that supply operands to the ALU and store the results of ALU operations, and a control unit that fetches instructions from memory and “executes” them by directing the coordinated operations of the ALU, registers and other components. The processing unit of the control unit 140 may also include a microprocessor and a microcontroller.

The communication unit of the control unit 140 may include a device capable of wireless or wired communication between other wireless or wired devices via at least one of Wi-Fi, Wi-Fi Direct, infrared (IR) wireless communication, satellite communication, broadcast radio communication, Microwave radio communication, Bluetooth, Bluetooth Low Energy (BLE), Zigbee, near field communication (NFC), and radio frequency (RF) communication, USB, global positioning system (GPS), Firewire, and Ethernet.

The storage unit of the control unit 140 may include a random access memory (RAM), a read-only memory (ROM), a hard disk, a flash drive, a database connected to the Internet, cloud-based storage, Internet-based storage, or any other type of storage unit.

The processing unit of the control unit 140 may access the Internet via the communication unit to allow the user to access a website, and/or may allow a mobile application and/or the software application to be executed using the processing unit. For ease of description, the mobile and/or the software application will be hereinafter referred to as an app. The app may be downloaded from the Internet to be stored on the storage unit of the control unit 140.

The control unit 140 may be disposed within at least a portion of the main body 110 and/or connected to the sensor 120 and/or the pressure dissemination unit 130. The control unit 140 executing the app may control the pressure sensation from the pressure dissemination unit 130. In other words, the control unit 140 may determine a pressure level of the pressured sensation based on the app. Also, the control unit 140 may determine appropriate responses of the sensor 120 based on the sensor 120 detecting the at least one sound from the vehicle corresponding to the autopilot warning and/or the at least one movement of the steering wheel 10 corresponding to the autopilot warning.

Furthermore, the control unit 140 may send a signal to the pressure dissemination unit 130 to continue using the pressured sensation for a predetermined period of time (e.g., twenty seconds) to satisfy a requirement of the autopilot operation to touch the steering wheel 10.

The power source 150 may include a battery and a solar cell, but is not limited thereto.

The power source 150 may be disposed within at least a portion of the main body 110. The power source 150 may provide power to the sensor 120, the pressure dissemination unit 130, and/or the control unit 140.

The fastener 160 may include an adhesive (e.g., tape, glue), a clip, a clasp, a clamp, a cord, a wire, a string, a magnet, and/or any combination thereof, but is not limited thereto.

The fastener 160 may be disposed on at least a portion of the main body 110. The fastener 160 may removably connect the main body 110 to the steering wheel 10, such that the main body 110 may be suspended on the steering wheel 10.

Therefore, the steering wheel attachment device 100 may simulate touch of the user to the steering wheel 10 during use of the autopilot. Additionally, the steering wheel attachment device 100 may facilitate full self-driving without requiring the touch of the user on the steering wheel 10, such that the vehicle may be driven hands free.

The present general inventive concept may include a steering wheel attachment device 100 removably connected to at least a portion of a steering wheel 10 of a vehicle, the steering wheel attachment device 100 including a main body 110, and a pressure dissemination unit 130 disposed within at least a portion of the main body 110 to provide a pressured sensation to the steering wheel 10 corresponding to a touch by a user.

The steering wheel attachment device 100 may further include a sensor 120 disposed within at least a portion of the main body 110 to detect at least one of at least one sound from the vehicle corresponding to an autopilot warning of the vehicle and at least one movement of the steering wheel 10 corresponding to the autopilot warning while an autopilot operation of the vehicle is activated.

The steering wheel attachment device 100 may further include a control unit 140 disposed within at least a portion of the main body 110 to control the pressured sensation from the pressure dissemination unit 130.

The control unit 140 may send a signal to the pressure dissemination unit 130 to continue using the pressured sensation for a predetermined period of time to satisfy a requirement of the autopilot operation to touch the steering wheel 10.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. A steering wheel attachment device removably connected to at least a portion of a steering wheel of a vehicle, the steering wheel attachment device comprising:
a main body; and
a pressure dissemination unit disposed within at least a portion of the main body to provide a pressured sensation to the steering wheel corresponding to a touch by a user.

2. The steering wheel attachment device of claim 1, further comprising:
a sensor disposed within at least a portion of the main body to detect at least one of at least one sound from the vehicle corresponding to an autopilot warning of the vehicle and at least one movement of the steering wheel corresponding to the autopilot warning while an autopilot operation of the vehicle is activated.

3. The steering wheel attachment device of claim 1, further comprising:
a control unit disposed within at least a portion of the main body to control the pressured sensation from the pressure dissemination unit.

4. The steering wheel attachment device of claim 3, wherein the control unit sends a signal to the pressure dissemination unit to continue using the pressured sensation for a predetermined period of time to satisfy a requirement of the autopilot operation to touch the steering wheel.
